(19) United States
(12) Patent Application Publication
(10) Pub. No.: US 2025/0324255 A1
(43) Pub. Date: Oct. 16, 2025

(54) SECURE ACCESS SERVICE EDGE INTERCONNECT PLATFORM

(71) Applicant: Palo Alto Networks, Inc., Santa Clara, CA (US)

(72) Inventors: Raghavaiah Avula, San Jose, CA (US); Bhaskar Bhupalam, Fremont, CA (US); Jining Tian, Saratoga, CA (US); Jennifer Yuan, San Ramon, CA (US); Arivu Mani Ramasamy, San Jose, CA (US)

(21) Appl. No.: 19/064,542

(22) Filed: Feb. 26, 2025

Related U.S. Application Data
(60) Provisional application No. 63/634,210, filed on Apr. 15, 2024.
(60) Provisional application No. 63/634,219, filed on Apr. 15, 2024.
(60) Provisional application No. 63/661,476, filed on Jun. 18, 2024.

(51) Int. Cl. H04W 12/088; H04W 12/102; H04W 12/122

(52) U.S. Cl. CPC H04W 12/088; H04W 12/102; H04W 12/122

(57) ABSTRACT

Techniques for providing security for providing a Secure Access Service Edge (SASE) Interconnect Platform are disclosed. In some embodiments, a system, process, and/or computer program product for a SASE Interconnect Platform includes receiving ingress Service Provider (SP) data plane traffic for a tenant from an SP backbone to a SASE cloud network for security processing via an Interconnect that is configured for a compute region and an IP block and an Autonomous System Number (ASN) to advertise the IP block in Border Gateway Protocol (BGP); extracting contextual information associated with the SP data plane traffic to determine a security policy to apply to the SP data plane traffic; enforcing the security policy on the SP data plane traffic to provide secured SP data plane traffic using a Security Processing Node (SPN); and egressing the secured SP data plane traffic back to the SP backbone or to an external network.

### CROSS REFERENCE TO OTHER APPLICATIONS

This application claims priority to U.S. Provisional Patent Application No. 63/634,210 entitled SECURE ACCESS SERVICE EDGE FOR MOBILE NETWORKS filed Apr. 15, 2024, U.S. Provisional Patent Application No. 63/634,219 entitled SECURE ACCESS SERVICE EDGE FOR MOBILE NETWORKS filed Apr. 15, 2024, and U.S. Provisional Patent Application No. 63/661,476 entitled SECURE ACCESS SERVICE EDGE SOLUTION FOR PROVIDING ENHANCED SECURITY FOR MOBILE NETWORKS filed Jun. 18, 2024, all of which are incorporated herein by reference for all purposes.

### BACKGROUND OF THE INVENTION

A firewall generally protects networks from unauthorized access while permitting authorized communications to pass through the firewall. A firewall is typically a device or a set of devices, or software executed on a device, such as a computer, that provides a firewall function for network access. For example, firewalls can be integrated into operating systems of devices (e.g., computers, smart phones, or other types of network communication capable devices). Firewalls can also be integrated into or executed as software on computer servers, gateways, network/routing devices (e.g., network routers), or data appliances (e.g., security appliances or other types of special purpose devices).

Firewalls typically deny or permit network transmission based on a set of rules. These sets of rules are often referred to as policies. For example, a firewall can filter inbound traffic by applying a set of rules or policies. A firewall can also filter outbound traffic by applying a set of rules or policies. Firewalls can also be capable of performing basic routing functions.

### BRIEF DESCRIPTION OF THE DRAWINGS

Various embodiments of the invention are disclosed in the following detailed description and the accompanying drawings.

FIG. 1 is a block diagram of a Service Access Service Edge (SASE) interconnect platform solution for any network fabric for providing enhanced security in accordance with some embodiments.

FIG. 2 is another block diagram of a SASE interconnect platform solution for any network fabric for providing enhanced security in accordance with some embodiments.

FIG. 3 is another block diagram of a SASE interconnect platform solution for any network fabric for providing enhanced security that includes the configuration and processing flow in accordance with some embodiments.

FIG. 4 is another block diagram that illustrates a control plane for eBGP routing for a SASE interconnect platform solution for any network fabric for providing enhanced security in accordance with some embodiments.

FIG. 5 is another block diagram that illustrates a control plane for eBGP routing for a SASE interconnect platform solution for any network fabric for providing enhanced security in accordance with some embodiments.

FIG. 6 is a flow diagram for a SASE interconnect platform solution for any network fabric for providing enhanced security in accordance with some embodiments.

FIG. 7 is a flow diagram for a zero trust network access (ZTNA) solution for a 5G SASE with explicit proxy for providing enhanced security in accordance with some embodiments.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A firewall generally protects networks from unauthorized access while permitting authorized communications to pass through the firewall. A firewall is typically a device, a set of devices, or software executed on a device that provides a firewall function for network access. For example, a firewall can be integrated into operating systems of devices (e.g., computers, smart phones, or other types of network communication capable devices). A firewall can also be integrated into or executed as software applications on various types of devices or security devices, such as computer servers, gateways, network/routing devices (e.g., network routers), or data appliances (e.g., security appliances or other types of special purpose devices).

Firewalls typically deny or permit network transmission based on a set of rules. These sets of rules are often referred to as policies (e.g., network policies or network security policies). For example, a firewall can filter inbound traffic by applying a set of rules or policies to prevent unwanted outside traffic from reaching protected devices. A firewall can also filter outbound traffic by applying a set of rules or policies (e.g., allow, block, monitor, notify or log, and/or other actions can be specified in firewall/security rules or firewall/security policies, which can be triggered based on various criteria, such as described herein). A firewall may also apply anti-virus protection, malware detection/prevention, or intrusion protection by applying a set of rules or policies.

Security devices (e.g., security appliances, security gateways, security services, and/or other security devices) can include various security functions (e.g., firewall, anti-malware, intrusion prevention/detection, proxy, and/or other security functions), networking functions (e.g., routing, Quality of Service (QoS), workload balancing of network related resources, and/or other networking functions), and/or other functions. For example, routing functions can be based on source information (e.g., source IP address and port), destination information (e.g., destination IP address and port), and protocol information.

A basic packet filtering firewall filters network communication traffic by inspecting individual packets transmitted over a network (e.g., packet filtering firewalls or first generation firewalls, which are stateless packet filtering firewalls). Stateless packet filtering firewalls typically inspect the individual packets themselves and apply rules based on the inspected packets (e.g., using a combination of a packet's source and destination address information, protocol information, and a port number).

Application firewalls can also perform application layer filtering (e.g., using application layer filtering firewalls or second generation firewalls, which work on the application level of the TCP/IP stack). Application layer filtering firewalls or application firewalls can generally identify certain applications and protocols (e.g., web browsing using HyperText Transfer Protocol (HTTP), a Domain Name System (DNS) request, a file transfer using File Transfer Protocol (FTP), and various other types of applications and other protocols, such as Telnet, DHCP, TCP, UDP, and TFTP (GSS)). For example, application firewalls can block unauthorized protocols that attempt to communicate over a standard port (e.g., an unauthorized/out of policy protocol attempting to sneak through by using a non-standard port for that protocol can generally be identified using application firewalls).

Stateful firewalls can also perform stateful-based packet inspection in which each packet is examined within the context of a series of packets associated with that network transmission's flow of packets/packet flow (e.g., stateful firewalls or third generation firewalls). This firewall technique is generally referred to as a stateful packet inspection as it maintains records of all connections passing through the firewall and is able to determine whether a packet is the start of a new connection, a part of an existing connection, or is an invalid packet. For example, the state of a connection can itself be one of the criteria that triggers a rule within a policy.

Advanced or next generation firewalls can perform stateless and stateful packet filtering and application layer filtering as discussed above. Next generation firewalls can also perform additional firewall techniques. For example, certain newer firewalls sometimes referred to as advanced or next generation firewalls can also identify users and content. In particular, certain next generation firewalls are expanding the list of applications that these firewalls can automatically identify to thousands of applications. Examples of such next generation firewalls are commercially available from Palo Alto Networks, Inc. (e.g., Palo Alto Networks' PA Series next generation firewalls, Palo Alto Networks' VM Series virtualized next generation firewalls, and CN Series container next generation firewalls, which can also be implemented using SD-WAN devices).

For example, Palo Alto Networks' next generation firewalls enable enterprises and service providers to identify and control applications, users, and content—not just ports, IP addresses, and packets-using various identification technologies, such as the following: App-ID™ (e.g., App ID) for accurate application identification, User-ID™ (e.g., User ID) for user identification (e.g., by user or user group), and Content-ID™ (e.g., Content ID) for real-time content scanning (e.g., controls web surfing and limits data and file transfers). These identification technologies allow enterprises to securely enable application usage using business-relevant concepts, instead of following the traditional approach offered by traditional port-blocking firewalls. Also, special purpose hardware for next generation firewalls implemented, for example, as dedicated appliances generally provides higher performance levels for application inspection than software executed on general purpose hardware (e.g., such as security appliances provided by Palo Alto Networks, Inc., which utilize dedicated, function specific processing that is tightly integrated with a single-pass software engine to maximize network throughput while minimizing latency for Palo Alto Networks' PA Series next generation firewalls).

Security service providers also offer various commercially available cloud-based security solutions including various firewall, VPN, including Secure Access Service Edge (SASE), and various other security related services. For example, some security service providers have their own data centers in multiple geographies across the world to provide their customers such cloud-based security solutions.

Generally, a secure access service edge (SASE) brings together networking and network security services in a single cloud-based platform. This way, organizations can embrace cloud and mobility while reducing the complexity of dealing with multiple point products as well as saving IT, financial, and human resources.

For example, a SASE solution can generally include networking capabilities that an enterprise already uses. SASE can integrate the following networking features into a cloud-based infrastructure: SD-WAN edge devices, VPN services, and web proxying, which are each further described below.

Software-defined wide area network (SD-WAN) edge devices can provide easier connectivity for branch offices. With SASE, these devices are connected to a cloud-based infrastructure rather than to physical SD-WAN hubs located in other locations. By moving to the cloud, enterprises can eliminate the complexity of managing physical SD-WAN hubs and promote interconnectivity between branch offices.

Virtual private network (VPN) services incorporated by a SASE solution enable enterprises to route traffic through a VPN (e.g., using IPsec tunnels) to the SASE solution, and then to any application in the public or private cloud, delivered via Software as a Service (SaaS), or on the Internet. Traditional VPN was used for remote access to the internal data center, but it is typically not optimized for the current/evolving cloud computing environment.

Web proxying provides an alternate means of securely connecting users to applications by inspecting web-based protocols and traffic. Proxies were typically used for web security enforcement, but due to their inherent security limitations, they are now typically used as an architectural alternative for device traffic that cannot be fully inspected (e.g., personal devices that cannot accept an endpoint agent to force all web and non-web traffic through security inspection). When implemented as part of a SASE solution, proxies can offer organizations with legacy architectures an easier way of adopting the more robust security capabilities SASE has to offer.

In addition, SASE can incorporate the network security service tools enterprises have generally relied upon in prior computing environments. In a comprehensive SASE solution, the following security services can be delivered through a cloud-based infrastructure: zero trust network access (ZTNA), firewall/security as a service (FWaaS), secure web gateways (SWG), data loss prevention (DLP), and cloud access security broker (CASB), which are each further described below.

Zero Trust Network Access (ZTNA) applies the Zero Trust secure computing approach (e.g., never trust, always verify) to the cloud computing environment. For example, ZTNA can be applied to require that every user authenticate to access the cloud, restricting access and minimizing the risk of, for example, data loss. However, ZTNA solutions based on a software-defined perimeter (SDP) model can lack content inspection capabilities needed for consistent security protection for enterprises. Also, moving to a cloud-based SASE infrastructure can eliminate the complexity of connecting to a gateway. For example, users, devices, and apps can be identified no matter where they connect from, and the below further described ZTNA solutions of protecting applications can be applied across all services, including data loss prevention (DLP) and threat prevention.

Firewall as a service (FWaaS) provides next-generation firewall features in the cloud computing environment (e.g., also referred to herein as the cloud), thereby removing the need for physical hardware at branch and retail locations. For example, SASE solutions can integrate FWaaS into its cloud-based platform, allowing simplified management and deployment.

### Overview of Techniques for Service Access Service Edge (SASE) Interconnect Platform Solution for Any Network Fabric

Technical and security challenges with integration of devices connecting with Secure Access Service Edge (SASE) environments for any network fabric (e.g., via different types of networks, such as mobile/cellular including, for example, 4G/LTE, 5G, 6G; Internet of Things (IoT); Wi-Fi; SD-WAN; and/or other types of networks) exist.

For example, there exists a need to effectively and efficiently connect a service provider network to a SASE environment to support both IPsec and non-IPsec traffic for securely transferring and processing the traffic for security (e.g., via a security processing node (SPN) of the SASE environment). Many service providers desire to process the network traffic via their own service provider network after security processing is performed using the SASE environment (e.g., this provides various advantages to the service provider for traffic flow within their own internal service provider network).

Another technical challenge currently exists in SASE environments in which all egress traffic is performed via a cloud computing provider's network/backbone (e.g., Google Cloud Platform (GCP), Amazon Web Services (AWS), and/or other cloud computing providers) based on a compute region and traffic latency as well as high-availability then depends on such cloud computing providers, which can be expensive as compared with egress via a service provider network/backbone along with higher latency metrics.

As such, there exists a need for improved integration for any network fabric with SASE environments.

Secure Access Service Edge (SASE) generally refers to providing converged network and security as a service capabilities, including Software Defined Wide Area Networking (SD-WAN), Secure Web Gateway (SWG), Cloud Access Security Broker (CASB), firewall as a service (e.g., using a Network Gateway Firewall (NGFW), which can be implemented using a VM-based or container-based firewall, such is in a cloud-based computing environment), and Zero Trust Network Access (ZTNA). Prisma Access is an example SASE solution that is commercially available from Palo Alto Networks, Inc., headquartered in Santa Clara, CA, and/or other SASE solutions are commercially available from other network/security vendors.

Specifically, what are needed are new and improved solutions for monitoring such network traffic and applying intelligent security for zero trust using a SASE interconnect platform solution for any network fabric, such as for mobile devices (e.g., UEs) communicating over service provider networks (e.g., mobile/cellular networks associated with one or more service providers, such as AT&T, Verizon, etc.) and/or other types of network fabric (e.g., IoT, Wi-Fi, IPsec/agent, etc.).

For example, there is a need for a SASE interconnect platform solution to provide a comprehensive and Secure Service Edge (SSE) solution for any network fabric.

Accordingly, the disclosed techniques for providing a SASE interconnect platform solution for providing enhanced security for any network fabric facilitate a system, a process, and/or a computer program product for applying intelligent security for zero trust using a SASE interconnect platform solution for any network fabric as will now be further described below.

For example, the disclosed techniques for providing a SASE interconnect platform solution for providing enhanced security for any network fabric includes monitoring network traffic and applying intelligent security for zero trust for devices communicating via mobile network environments using a SASE solution, such as for mobile devices (e.g., UEs) connecting to and/or communicating over service provider networks (e.g., mobile networks associated with one or more service providers, such as AT&T, Verizon, etc.) for applying context-based and/or enhanced security in mobile networks based on subscriber-ID/International Mobile Subscriber Identity (IMSI)/Subscription Permanent Identifier (SUPI), equipment-ID/International Mobile Equipment Identity (IMEI)/Permanent Equipment Identifier (PEI), subscriber number (GPSI/MSISDN/external identifier), Network Slice ID/Single Network Slice Selection Assistance Information (S-NSSAI), User Equipment (UE) IP, Access Point Name (APN)/Data Network Name (DNN), Radio Access Technology (RAT) Type information, IP to mobile subscriber traffic mappings, and/or other context-based information to facilitate enhanced security for such mobile devices communicating via mobile networks to access enterprise networks, applications including Software as a Service (SaaS)-based applications or other cloud based applications/services, and/or other Internet activities, such as will be further described below.

In some embodiments, a system, a process, and/or a computer program product for a SASE interconnect platform solution for providing enhanced security for any network fabric includes receiving ingress Service Provider (SP) data plane traffic for a tenant from an SP backbone to a SASE cloud network for security processing via an Interconnect (e.g., with a cloud network service provider Service Level Agreement (SLA)) that is configured for a compute region and an IP block and Autonomous System Number (ASN) to advertise the IP block in Border Gateway Protocol (BGP); extracting contextual information associated with the SP data plane traffic to determine a security policy to apply to the SP data plane traffic; enforcing the security policy on the SP data plane traffic to provide secured SP data plane traffic using a Security Processing Node (SPN); and egressing the secured SP data plane traffic back to the SP backbone or to an external network.

In an example implementation, the disclosed SASE interconnect platform solution for providing enhanced security for any network fabric (e.g., 4G/5G/6G cellular, private 5G/6G, Wi-Fi, IoT, etc.) provides for the following as briefly summarized below.

1. The disclosed SASE interconnect platform solution allows for connecting an Internet Service Provider (ISP)/Service Provider (SP) network to the SASE environment (e.g., reside traffic within an ISP/SP network with an interconnect attach with the SASE environment for a specific tenant).

2. The disclosed SASE interconnect platform solution supports generic identity interface and vertical scale of virtual LAN (vLAN) attachment to support data traffic via an interconnect (e.g., either partner or dedicated).

3. The disclosed SASE interconnect platform solution supports both IPsec as well as non-IPsec traffic for any network fabric (e.g., 4G/5G/6G cellular, private 5G/6G, Wi-Fi, IoT, etc.) to SASE security processing nodes (SPNs).

4. The disclosed SASE interconnect platform solution supports egress hybrid backbone support for loopback traffic to the SP/SASE default backbone.

In some embodiments, a system, a process, and/or a computer program product for a SASE interconnect platform solution for providing enhanced security for any network fabric further includes providing support for IPsec and non-IPsec traffic via network attach to the SASE environment for security processing and network transport for any network fabric (e.g., 4G/5G/6G cellular, private 5G/6G, Wi-Fi, IoT, etc.).

In some embodiments, a system, a process, and/or a computer program product for a SASE interconnect platform solution for providing enhanced security for any network fabric further includes providing support for SP Points of Presence (PoP) in a plurality of regions.

In some embodiments, a system, a process, and/or a computer program product for a SASE interconnect platform solution for providing enhanced security for any network fabric further includes a cloud router for advertising IP ranges and the SP network provides the BGP summarization (e.g., min/24 to Internet).

For example, the disclosed techniques for providing for a SASE interconnect platform solution for providing enhanced security for any network fabric can be applied to reside traffic within a service provider network with interconnect attach (e.g., for specific tenants), such as further described below.

As another example, the disclosed techniques for providing for a SASE interconnect platform solution for providing enhanced security for any network fabric can be applied to support both IPsec and non-IPsec traffic via network attach to the SASE environment for secure processing and network transport for any network fabric (e.g., via different types of networks, such as mobile/cellular including 4G/LTE, 5G, 6G, such as enterprise 5G networks; Internet of Things (IoT); Wi-Fi networks; service provider networks; SD-WAN networks; etc.), such as further described below.

As another example, the disclosed techniques for providing for a SASE interconnect platform solution for providing enhanced security for any network fabric can support egress hybrid backbone support for loopback traffic to the service provider/SASE environment default backbone, such as further described below.

Accordingly, new and improved security solutions that facilitate applying security (e.g., network-based security) for zero trust in a Service Access Service Edge (SASE) interconnect platform environment (e.g., the security platform can be implemented using a firewall (FW)/Next Generation Firewall (NGFW), a network sensor acting on behalf of the firewall, or another (virtual) device/component that can implement security policies using the disclosed techniques, including, for example, Palo Alto Networks' Prisma Access Secure Service Edge (SSE), Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques) (e.g., a 4G/LTE, 5G, 6G, and/or later versions of mobile networks), and in some cases, on various interfaces (e.g., N6, etc.) and protocols (e.g., PFCP, RADIUS, Diameter, etc.) in mobile network environments are disclosed in accordance with some embodiments.

These and other embodiments and examples for providing a SASE interconnect platform solution for providing enhanced security for any network fabric will be further described below.

### Example System Architectures for Service Access Service Edge (SASE) Interconnect Platform Solution for Any Network Fabric

Accordingly, in some embodiments, the disclosed techniques for providing a SASE interconnect platform solution for any network fabric (e.g., such as for applying intelligent security for zero trust in mobile networks, including 4G/LTE, 5G, 6G, such as enterprise 5G networks; and/or other types of networks, such as Internet of Things (IoT); Wi-Fi networks; service provider networks, SD-WAN networks; etc.) can be provided using security platforms (e.g., the security function(s)/platform(s) can be implemented using Palo Alto Networks' Prisma Access Secure Service Edge (SSE), a firewall (FW)/Next Generation Firewall (NGFW), a network sensor acting on behalf of the firewall, or another (virtual) device/component that can implement a firewall as a service entity for enforcing one or more security policies using the disclosed techniques, such as PANOS executing on a virtual/physical NGFW solution commercially available from Palo Alto Networks, Inc. or another security platform/NFGW, including, for example, Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques, including using SD-WAN devices and/or clusters executing firewall as a service entities) and are configured to provide deep packet inspection (DPI) capabilities (e.g., including stateful inspection) of, for example, user/subscriber sessions (e.g., user/subscriber traffic) provided to the SASE solution via a secure channel, such as an interconnect (e.g., a cloud-to-cloud interconnect, such as from a Google Cloud Platform (GCP) cloud-based environment for the service provider's core mobile network into a SASE cloud-based environment) to apply security on traffic in mobile networks based on a policy (e.g., layer-7 security and/or other security policy enforcement) as further described below.

Specifically, as will now be described with respect to various system embodiments, context-based security can be applied to network traffic (e.g., mobile device network traffic, IoT device traffic, etc.) from any network fabric using a SASE solution, such as will be further described below with respect to various embodiments. In an example implementation, context-based security can be applied using SASE to such traffic passing thru mobile networks based on one or more of the following: a subscriber/user including IMSI, IMEI, Mobile Station International Subscriber Directory Number (MSISDN)/external identifier, RAT type, Network Slice, DNN/APN, location, user IP, and/or other contextual information.

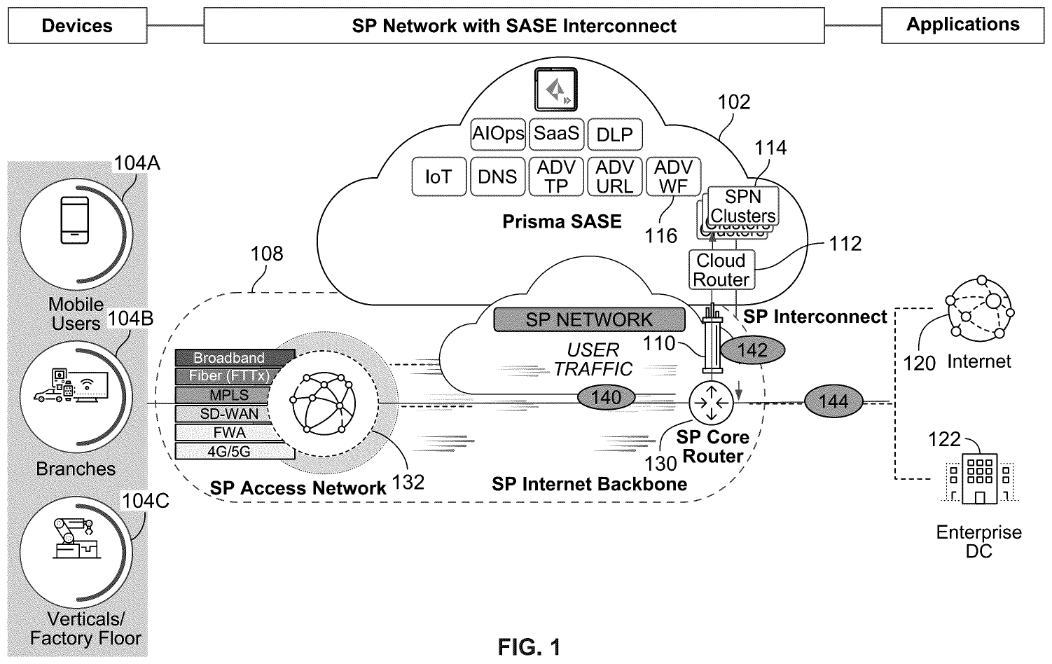

FIG. 1 is a block diagram of a Service Access Service Edge (SASE) interconnect platform solution for any network fabric for providing enhanced security in accordance with some embodiments. The disclosed techniques for providing a SASE solution for any network fabric is shown in FIG. 1 with respect to an example network environment that includes a Service Provider (SP) access network 132 with multiple types of networks, shown as broadband, fiber, MPLS, SD-WAN, FWA, and 4G/5G in this example implementation. However, it would be apparent to one of ordinary skill in the art that the disclosed techniques can similarly be applied to various other example network environments, such as enterprise 5G/6G or later mobile network environments, optical networks, satellite networks, etc.

FIG. 1 illustrates an example architecture for interconnecting the SP cloud-based network environment as shown at 108 (e.g., including the SP Internet backbone and SP access network shown at 132) with a SASE cloud-based environment (e.g., also referred to herein as SASE cloud or SASE environment) as shown at 102 (e.g., shown as a Prisma SASE hyperscaler cloud-based solution in this example, which is a commercially available SASE solution from Palo Alto Networks, Inc., headquartered in Santa Clara, CA, and/or other commercially/publicly available SASE solutions can similarly be used) using a cloud-to-cloud interconnect 110 (e.g., shown in this example as a service provider (SP) interconnect, also referred to herein as the Interconnect). In an example implementation, a Google Cloud Platform (GCP) Partner interconnect can be used to connect the SP network environment (108) with the Prisma SASE cloud (102) (e.g., or for other available cloud-based computing environments, such as Amazon Web Services (AWS), Microsoft Azure, etc., or other cloud-to-cloud interconnects provided for those cloud-based computing environments can similarly be used).

Specifically, the SP Interconnect connection (e.g., as shown at 110 in FIG. 1) can be used for securely passing traffic between these cloud-based network environments 102 and 108. More specifically, user traffic passes through the SP Internet backbone as shown at 140 thru SP interconnect 110 for security processing in SASE cloud 102 (e.g., as will be further described below). The secured user traffic is returned thru SP interconnect 110 as shown at 142, and the secured user traffic is routed using an SP core router 130 and routed as shown at 144 to an external network, such as the Internet 120 or an enterprise data center (DC) 122.

Referring to SASE cloud 102, in this example implementation, the SASE cloud includes a cloud router 112 for routing user traffic received from SP interconnect 110 to Security Processing Node (SPN) clusters 114. Specifically, SPN clusters 114 provide firewall entities, specifically, firewalls as a service (FWaaS), for implementing the disclosed enhanced, context-based security for mobile devices connecting to the SP network environment shown at 108 (e.g., the security function(s)/platform(s) can be implemented using a firewall (FW)/Next Generation Firewall (NGFW), a network sensor acting on behalf of the firewall, or another (virtual) device/component that can implement security policies using the disclosed techniques, including, for example, Palo Alto Networks' PA Series next generation firewalls, Palo Alto Networks' VM Series virtualized next generation firewalls, and CN Series container next generation firewalls, and/or other commercially available virtual-based or container-based firewalls can similarly be implemented and configured to perform the disclosed techniques via these firewall as a service entities) as further described below.

As referred to herein, IMSI is the concept referred to by ITU-T as the “International Mobile Subscription Identity.” IMSI is a 14 or 15 digit number.

As also referred to herein, SUPI is a globally unique 5G “Subscription Permanent Identifier” allocated to each subscriber in the 5G system. As per 3GPP T.S 23.003 version 16.9.0, a SUPI type may indicate an IMSI, a network access identifier (NAI), a Global Line Identifier (GLI), or a Global Cable Identifier (GCI).

As also referred to herein, International Mobile Equipment Identifier (IMEI) is defined in 3GPP TS 23.003 available at https://portal.3gpp.org/desktopmodules/Specifications/SpecificationDetails.aspx?specificationId=729.

In example implementations, the SP access network environment (108) can also include a 4G/5G Radio Access Network (RAN) access and/or access other networks including, for example, Broadband, Fiber (e.g., FTTx), MPLS, SD-WAN, Wi-Fi, and Fixed Wireless Access (FWA), to facilitate data communications for subscribers (e.g., using User Equipment (UE), such as smart phones, laptops, computers (which may be in a fixed location), including for mobile users 104A (e.g., including, for example, Internet of Things (IoT) devices), branches 104B (e.g., branch offices/remote sites of an enterprise), and/or other cellular enabled computing devices/equipment including verticals/factory floor devices (e.g., Industrial IoT (HoT), Commercial IoT (CIoT)) as shown at 104 C (e.g., verticals/factory floor CIoT devices), and/or other network communication enabled devices, including over a Packet Data Network (PDN) (e.g., the Internet) 120 to access various applications, web services, content hosts, etc. and/or other networks) as well as to enterprise networks, such as for an enterprise data center (DC) as shown at 122.

As also shown in FIG. 1, service provider (SP) core router 130 in the service provider (SP) network 108 is in communication with SP Interconnect 110 for passing the user traffic (e.g., including user plane traffic associated with any connected UEs 104A, branch offices 104B, and/or verticals/factory floor 104C) to the SASE environment 102 as similarly described above. SP core router 130 is also in communication with enterprise DC 122 as well as the Internet 120 via the SP Interconnect shown at 110.

Specifically, the security is provided for the user traffic by passing the traffic from the SP network (108) via the SP Interconnect (110) to the firewall as a service (FWaaS) entities, shown as 5G SPN clusters 114, via cloud router 112 (e.g., a security interconnect (I/C) router) as shown in FIG. 1. In an example implementation, the cloud router can provide layer-3 Border Gateway Protocol (BFG) routing from the SP Interconnect 110 to the 5G SPN clusters 114 to facilitate connections (e.g., including cross-connects for dynamic load balancing, etc.) on a region by region basis (e.g., North American cloud environments can be connected, European cloud environments can be connected, and Asian cloud environments can be connected, and/or other regions or smaller divisions of regions, such as by a country within Asia and a country within Europe, or Eastern United States, Central United States, Western United States, etc.). As such, the FWaaS entities/SPN clusters 114 can perform the disclosed enhanced, context-based security on such mobile device/user related traffic without having to locate the security/firewall entities within, for example, a 4G/5G core mobile network, which is often preferred by the mobile network service providers (e.g., for latency and/or other technical reasons, mobile network service providers/mobile service providers (MSPs) may not want to deploy 3^{rd} party vendor security services/equipment in the MSP's 4G/5G mobile core network).

As will be further described below, this interconnect between the SASE cloud and the SP network facilitates an effective and efficient mechanism for using the SASE solution to facilitate enhanced security for the user traffic passing through the SP network (e.g., based on UE IP, user identifier (ID), application (app) ID, IMEI, IMSI, location, network slice, RAT information, and/or other contextual information as will be further described below). For example, the SP access network as shown at 132 can provide access to different devices connecting via various types of networks, including broadband, fiber (FTTx), MPLS, SD-WAN, FWA, and 4G/5G as shown in this example SP network environment.

In some embodiments, the FWaaS entities provided via SPN clusters 114 are configured to provide the following DPI capabilities: DPI of Packet Forwarding Control Protocol (PFCP) traffic, Internet Protocol (IP) traffic, and/or other protocol formatted network traffic for the user traffic received via the cloud router 112 from the SP Interconnect 110. In an example implementation, the FWaaS entities are configured to provide DPI capabilities (e.g., including to identify a UE IP, user ID, app, IDIMSI/SUPI, IMEI/PEI, S-NSSAI, APN/DNN, and/or RAT Type information, etc.) of, for example, IP traffic that passes through SP network 108 and/or PFCP messages that pass through, for example, the N6 and/or other interfaces between SP core router 130 and other SP network entities within the SP network environment 108 to apply context-based security traffic based on a policy (e.g., layer-7 security and/or other security policy enforcement) as further described below.

In some embodiments, an SP Interconnect (SPI) is provided if the SP has a separate Internet breakout PoP from their mobile packet core network such that network traffic (e.g., including control plane traffic) is provided from the SP mobile packet core network to the SASE cloud network environment for the SPI as similarly described above.

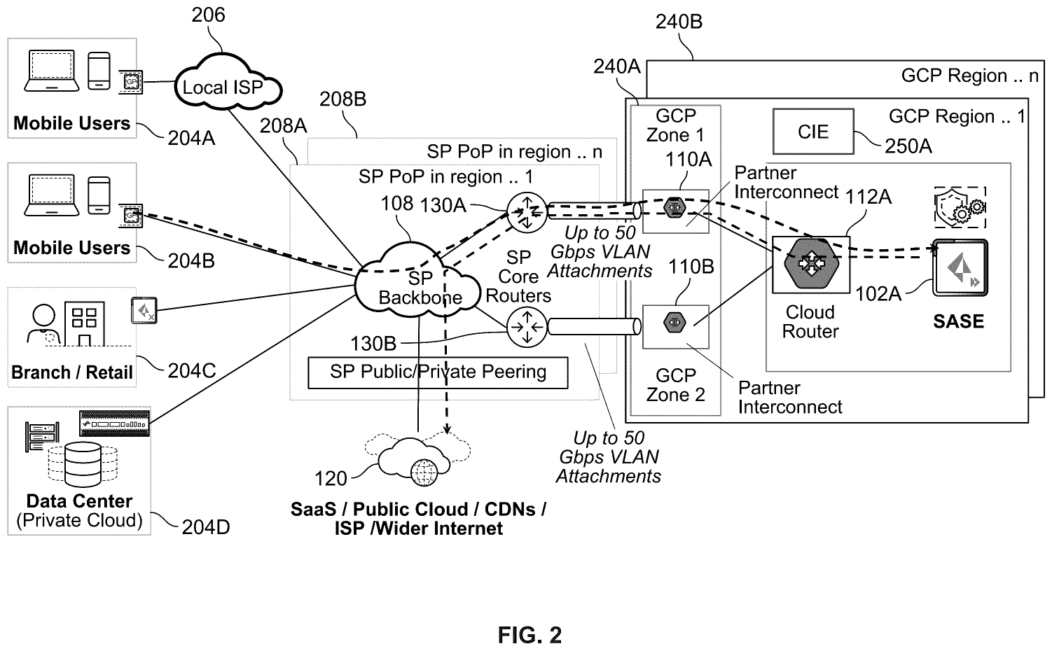

In some embodiments, an SP Interconnect (SPI) is provided if the SP has a separate Internet breakout PoP for SP PoP in distinct regions, such as will be further described below with respect to FIG. 2.

Specifically, in an example implementation, the FWaaS entities provided via SPN clusters 114 are configured to add an entry of the user traffic associated IP address (e.g., UE IP) and contextual information, such as user location, device information/ID, app ID, IMSI, IMEI, and S-NSSAI related to this subscriber/user (e.g., user ID) in a data store (not shown) (e.g., a database, such as an SQL or other type of commercially available database). In this example implementation, the firewall as a service entities receive signaling message(s) from the SP network (e.g., a 4G/5G core mobile network) (e.g., via an out-of-band) communication channel (e.g., using a Radius protocol, a Diameter protocol, and/or another protocol can similarly be used, such as via a proxy entity, such as the mobile core AAA entity) as part of a mobile user/device (UE) initial connection and authentication with, for example, the 4G/5G core mobile network. This signal message communication can include, for example, a UE IP address (UE IP), mobile phone number, IMSI, IMEI, location, APN/DNN, RAT, and/or other contextual information associated with the mobile device/user. Similarly, the core mobile network can also provide another message when the mobile device/user disconnects from the core mobile network, and then the SASE solution/firewall as a service entity/ies can remove the relevant entry of the UE IP and related context information from the database. In another example implementation, such out-of-band message communications can similarly be implemented using Application Programming Interfaces (APIs) (e.g., RESTful APIs) for secure communications between the SP network (e.g., 4G/5G core network) and the SASE cloud.

In one embodiment, the disclosed SASE techniques rely on the 4G/5G packet core mobile network for interpreting the PFCP messages and sending the summarized information (e.g., including various associated contextual information as described herein) via a communication mechanism (e.g., RADIUS accounting messages, DIAMETER messages, and/or another protocol can be similarly used, and/or an API communication mechanism can be similarly used) to the SASE solution.

In another embodiment, the security platform is configured to utilize DPI to extract various contextual information from monitored SP network protocols, which can include, for example in a use case of a 5G network, removing the entry of a UE IP and related contextual information from the database if either of the following events occur based on the monitoring of the PFCP protocol: (1) a PFCP session deletion request/response message to delete the PFCP control session; and (2) user/subscriber session(s) timeout message (e.g., such timeouts can be configurable). More specifically, in this example implementation in which the security platform is configured to utilize DPI to extract various contextual information from monitored 5G packet core mobile network protocols, the firewall as a service entities provided via SPN clusters 114 are configured to monitor PFCP messages including the following: (1) a PFCP Session Establishment Procedure (e.g., as per 3GPP T.S 29.244 v 18.3.0 (e.g., which is publicly available at https://portal.3gpp.org/desktopmodules/Specifications/SpecificationDetails.aspx?specificationId=3111), a PFCP Session Establishment procedure shall be used to set up a PFCP session between a CP function and a UP function and configure rules in the UP function so that the UP function can handle incoming packets); (2) a PFCP Session Modification Procedure (e.g., the PFCP Session Modification procedure shall be used to modify an existing PFCP session, e.g., to configure a new rule, to modify an existing rule, to delete an existing rule); and (3) a PFCP Session Deletion Procedure (e.g., the PFCP Session Deletion procedure shall be used to delete an existing PFCP session between the CP function and the UP function) to facilitate extraction of the above-described contextual information.

In this example implementation, the FWaaS entities provided via SPN clusters 114 are configured to provide various enhanced, context-based security based on the monitored user plane data traffic flows received via the Interconnect at the mapped firewall as a service entity/ies (e.g., to set up the flow information for each new UE connection to the 4G/5G core mobile network). The data traffic flows (e.g., sessions) can be correlated based on the source IP address for the data traffic flows the relevant UE IP received and stored above to associate such data traffic flows to the relevant context information associated with the UE IP. The FWaaS entity/ies can then select and apply a security policy to each data traffic flow using the relevant contextual information for each such data traffic flow.

As such, the disclosed SASE interconnect platform for any network fabric facilitates a cloud native SASE stack with SIM-based authentication, federation, and interconnect with SP networks, including core mobile networks (e.g., 4G/5G/6G/later mobile network core environments).

In this example implementation, the FWaaS entities provided via SPN clusters 114 are configured to provide various SASE related services, including, as shown in FIG. 1, Artificial Intelligence powered Operations (AIOps), Software as a Service (SaaS) secure and high-speed connections (e.g., for SalesForce, Microsoft Office 365, and/or other SaaS solutions), Data Loss Prevention (DLP) security, IoT security, Domain Name System (DNS) security, Advanced Threat Protection (ATP) security, Advanced Uniform Resource Link (URL) security, and/or other SASE/security related services.

In addition, the firewall as a service entities provided via SPN clusters 114 can also be in network communication with a Cloud Security Service 116 (e.g., a commercially available cloud-based security service, such as the WildFire™ (ADV WF) cloud-based malware analysis environment that is a commercially available cloud security service provided by Palo Alto Networks, Inc., which includes automated security analysis of malware samples as well as security expert analysis, or a similar solution provided by another vendor can be utilized), such as via the Internet. For example, Cloud Security Service 116 can be utilized to provide the security platforms with dynamic prevention signatures for malware, DNS, URLs, CNC malware, and/or other malware as well as to receive malware samples for further security analysis.

Specifically, in this example implementation, the firewall as a service entities provided via SPN clusters 114 are configured to apply the above-described context-based security policy enforcement to the user traffic (e.g., mobile device/user traffic, such as for each inspected/monitored session/flow) that is received via the SP Interconnect 110 and then pass the user traffic (e.g., secured/clean mobile traffic) back to the SP network 108 for routing (e.g., egress) from the mobile core network to a destination for the mobile traffic (e.g., for each session/flow), such as from SP core router 130 to the Internet 120 (e.g., for SaaS applications and/or other applications/services, etc.) and/or to the Enterprise DC 122 (e.g., for on-premises applications/services, etc.), such as shown at 140, 142, and 144 in FIG. 1 as similarly described above.

FIG. 2 is another block diagram of a SASE interconnect platform solution for any network fabric for providing enhanced security in accordance with some embodiments. The disclosed techniques for providing a SASE interconnect platform solution for any network fabric are similarly shown in FIG. 2 with respect to a service provider (SP) point of presence (PoP) in different regions (e.g., region 1 as shown at 208A, . . . , region n as shown at 208B, etc. for facilitating different access points for the users of the SP that are in different geographical locations, such as Asia, Europe, North America, etc.), which are connected with SP interconnects to different GCP Regions for the SASE cloud processing as shown at 240A and 240B, respectively, as will be further described below. However, as also discussed above, it would be apparent to one of ordinary skill in the art that the disclosed techniques can similarly be applied to various other example service partner/service provider environments.

Referring to FIG. 2, in the SP PoP in region 1 as shown at 208A, network traffic from mobile users 204A via a local Internet Service Provider (ISP) 206, mobile users 204B (e.g., such as shown, both mobile users 204A and 204B are in communication via a VPN connection, such as GlobalProtect® (GP) that is a commercially available VPN client from Palo Alto Networks, Inc., headquartered in Santa Clara, CA, or another commercially/publicly available VPN client can similarly be used), branch/retail sites 204C, and a data center (private cloud) 204D are in communication with the SP backbone network 108 in given SP Point of Presence (PoP) region 1. As shown in FIG. 2, user traffic from mobile users 204A passes through the SP core router 130A to the SASE network via the SP interconnect 110A in Region 1 as shown at 240A (e.g., Google Cloud Platform (GCP) Region 1 in this example implementation, or other commercially available cloud computing platform solutions can similarly be used, such as AWS® or Microsoft Azure®). Cloud router 112A routes the user traffic to the SASE cloud environment 102A for inspection, such as similarly described above with respect to FIG. 1.

In an example implementation, the Enterprise/Service Provider (SP) creates an interconnection that includes the SP interconnect in a portal for a given compute region and a configured IP block along with an autonomous system number (ASN) to advertise the block in the border gateway protocol (BGP). For example, the cloud router can advertise IP ranges, and the SP network can be configured to perform BGP summarization (e.g., min/24 to Internet) and remove Google ASN 16550. In this example implementation, the Enterprise/Service Provider configures an identity processing configuration based on fabric integration, such as a cellular/Wi-Fi/IoT configured RADIUS setting to receive start/stop messages. This identity user mapping can be synchronized to a cloud identity engine (CIE) 250A for each given configured SASE tenant. After a region level Interconnect link up, the disclosed SASE Interconnect service can bring up resources on such tenants to receive data plane traffic via the SP Interconnect (e.g., shown at 110A and 110B in FIG. 2) (e.g., this traffic can be for, for example, Radius, data plane traffic, 4G/5G traffic, SaaS traffic, etc.).

In this example implementation, the user traffic that is routed to GCP Region 1 (240A) is routed via the cloud router (112A) to an SPN cluster (e.g., such as shown at 114 in FIG. 1) of the SASE cloud environment 102A and is then processed/inspected using the SPN cluster (e.g., executing a FWaaS entity(ies)) based on a network traffic type. For example, IPsec traffic for typical SASE traffic is inspected and routed to the SPN cluster based on the IP address associated with the IPsec traffic. In this example, non-IPsec traffic is processed and sent to the SPN cluster via a tunnel (e.g., Geneve tunnel with header for source and destination based on Radius user identity mapping). After completion of the SPN processing, either IPsec or non-IPsec (Geneve) traffic, based on transport type configured by enterprise/SP, is then routed back through the Interconnect backbone, such as similarly described above with respect to FIG. 1.

As an example use case, a cellular (e.g., 4G/5G/6G/later cellular network standards) mobile network service provider can utilize the disclosed techniques for providing SASE for their 5G network customers to offer enhanced security services as a managed service, such as to their enterprise customers that have 5G enterprise deployments and/or to their individual subscribers, such as for additional subscription fees for such enhanced security services.

As another example use case, a cellular (e.g., 4G/5G/6G/later cellular network standards) mobile network service provider can utilize the disclosed techniques for providing SASE for their own internal enterprise users for enhanced security services to protect/safeguard their internal enterprise users on their mobile network activities.

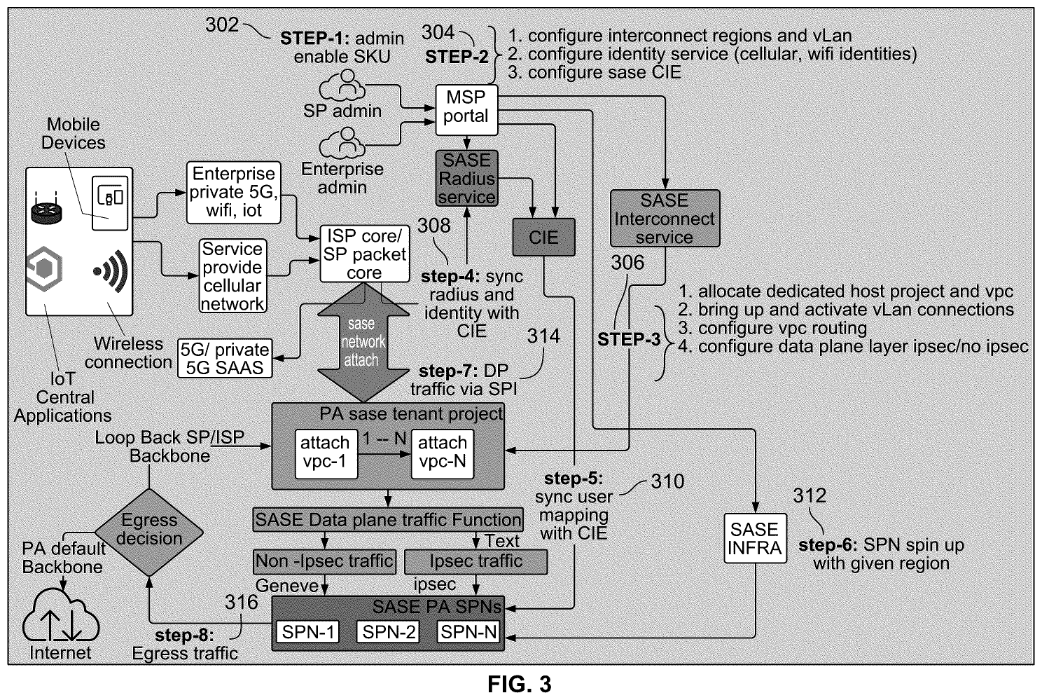

FIG. 3 is another block diagram of a SASE interconnect platform solution for any network fabric for providing enhanced security that includes the configuration and processing flow in accordance with some embodiments. The disclosed techniques for providing a SASE solution for any network fabric is shown in FIG. 3 with respect to an example network environment that includes a Service Provider (SP) access network (e.g., ISP core/SP packet core network) with multiple types of networks, shown as enterprise private 5G, Wi-Fi, IoT; service provider cellular, and 5G/private 5G SaaS networks in this example implementation. However, as also discussed above, it would be apparent to one of ordinary skill in the art that the disclosed techniques can similarly be applied to various other example service partner/service provider environments.

In this example implementation, the disclosed SASE interconnect platform solution for providing enhanced security for any network fabric (e.g., 4G/5G/6G cellular, private 5G/6G, Wi-Fi, IoT, etc.) provides for the following as briefly summarized below.

The disclosed SASE interconnect platform solution for any network fabric allows for connecting an Internet Service Provider (ISP)/Service Provider (SP) network to the SASE environment.

The disclosed SASE interconnect platform solution for any network fabric supports a generic identity interface and vertical scale of virtual LAN (vLAN) attachment to support data traffic via interconnect (e.g., either partner or dedicated).

The disclosed SASE interconnect platform solution for any network fabric supports both IPsec as well as non-IPsec traffic to SASE security processing nodes (SPNs) (e.g., supports both IPsec and non-IPsec traffic) via network attach to the SASE cloud network/environment for secure processing and network transport for any network fabric as shown in FIG. 3 (e.g., enterprise private 5G, IoT, Wi-Fi, service provider cellular traffic, etc.).

Also, the SP interconnect can be provided with a Service Level Agreement (SLA) with the cloud provider (e.g., within GCP).

In addition, the disclosed SASE interconnect platform solution for any network fabric is a configurable platform that allows for scaling horizontally.

Referring to FIG. 3, at step-1 as shown at 302, the interconnect SKU is enabled by the admin (e.g., SP admin and/or Enterprise admin) using a Managed Service Provider (MSP) portal.

At step-2 as shown at 304, the Enterprise/Service provider configures the interconnection, partner interconnect regions, and virtual Local Area Network (vLAN) (e.g., using the portal) for a given compute region and configures an IP block along with an Autonomous System Number (ASN) to advertise the block in the Border Gateway Protocol (BGP), such as similarly described above with respect to FIG. 2. For example, this configuration facilitates receiving ingress SP data plane/user traffic for a tenant from an SP backbone (e.g., ISP core/SP packet core network as shown in FIG. 3) to the SASE cloud network for security processing via the interconnect that is configured for a compute region and an IP block and ASN to advertise the IP block in BGP. As also shown at 304, the Enterprise/Service provider configures identity processing configuration and the SASE CIE based on the network fabric integration (e.g., cellular identities, which can be configured using RADIUS settings to receive start/stop messages, etc.).

In an example implementation, the cloud router (e.g., as shown at 112 in FIG. 1 and at 112A in FIG. 2) advertises the IP ranges and the SP side provides the BGP summarization (e.g., min/24 to the Internet).

In an example implementation, pairing keys create the vLAN connection (e.g., in which the pairing key is a unique key that allows a service provider to identify and connect to a given Virtual Private Cloud (VPC) network and associated Cloud Router, and the service provider uses the pairing keys to complete configuration of a VLAN attachment, such as similarly described herein). The pairing keys can be valid for a predetermined period of time (e.g., 7 days, 30 days, etc.).

At step-3 as shown at 306, the Enterprise/Service provider allocates a dedicated host project and virtual private connection (vpc), brings up and activates the vLAN connections, configures vpc routing, and configures the data plane layer for IPsec and non-IPsec traffic.

In this example implementation, once the regional interconnect link is up, then the SASE Interconnect service can bring up resources on the tenant to receive data plane/user traffic via the interconnect pipe (e.g., this traffic can include Radius traffic, data plane traffic, 5G SaaS traffic, etc.).

At step-4 as shown at 308, the Radius and identity/user information is automatically synchronized with/stored in the CIE, such as similarly described above with respect to FIG. 2.

At step-5 as shown at 310, the identity/user mapping is automatically synchronized to/stored in the CIE for a given configured SASE tenant (e.g., sync Radius and identity/user information with the CIE), such as similarly described above with respect to FIG. 2.

At step-6 as shown at 312, the SPN clusters are spun up for each given region.

At step-7 as shown at 314, data plane (DP)/user traffic is received via the SP interconnect. Deep packet inspection (DPI) is performed using the SPN clusters of the SASE cloud network. In this example implementation, the DP/user traffic is routed to the respective SPN based on a network traffic type (e.g., IPsec traffic or non-IPsec traffic, such as shown in FIG. 3). If it is IPsec traffic, then the IPsec traffic is routed to an SPN based on the assigned IP address associated with the IPsec traffic. For non-IPsec traffic, then the non-IPsec traffic is processed and routed to an SPN via a Geneve tunnel with a header for source and destination based on Radius user identity mapping.

At step-8 as shown at 316, after the SPN processing (e.g., for both IPsec and non-IPsec (Geneve) traffic), the secured/SPN processed DP/user traffic is egressed from the SASE cloud network. For example, the secured/SPN processed DP/user traffic is egressed from the SASE cloud network based on a transport type configured by the Enterprise/Service Provider route back to the Interconnect backbone or the GCP/Google backbone as shown in FIG. 3.

As such, the disclosed SASE interconnect platform solution for any network fabric allows Service Providers to provide a cloud native SASE stack with an interconnect with an SP network core (e.g., up to 400 or more Gbps interconnect capacity (full duplex) in this example implementation).

Also, all ingress/egress traffic can stay on the SP network without requiring additional security equipment in the SP network.

In addition, seamless layer-2 (L2) and layer-3 (L3) connectivity with BGP peering SP prefixes and BGP route advertisements is provided as similarly described above.

Further, global coverage across the entire SP network footprint is provided, and auto-scalability based on traffic volumes and enterprise/tenant growth is also provided.

Moreover, the disclosed SASE interconnect platform solution for any network fabric allows enterprises to utilize the comprehensive managed service from a single provider. This approach also facilitates a more efficient coordination of security policies across the enterprise and SASE cloud environment for the enterprise tenant. In addition, this approach avoids network and security fragmentation (e.g., as it secures all of the enterprise tenant's users, guests, contract workers, managed and unmanaged devices, branch offices, applications, and data). Finally, this approach provides for global coverage for an enterprise's branches, enterprise data centers, and SP networks.

Finally, the disclosed SASE interconnect platform solution for any network fabric facilitates comprehensive visibility and analytics (e.g., allowing for efficient automation and remediation).

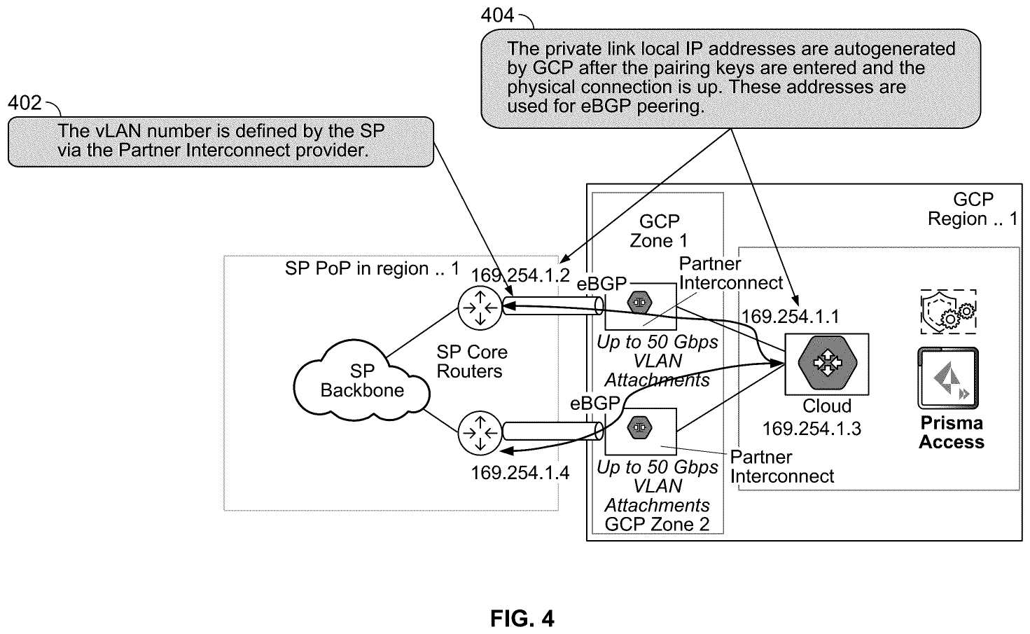

FIG. 4 is another block diagram that illustrates a control plane for eBGP routing for a SASE interconnect platform solution for any network fabric for providing enhanced security in accordance with some embodiments. As also discussed above, it would be apparent to one of ordinary skill in the art that the disclosed techniques can similarly be applied to various other example service partner/service provider environments.

Referring to FIG. 4, at 402, a vLAN number is defined by the service provider (SP) via the partner interconnect provider.

At 404, the private link local IP addresses (e.g., 169.254.1.1 and 169.254.1.3 as shown in FIG. 3) are auto-generated by the cloud network provider (e.g., GCP in this example) after the pairing keys, such as similarly described above, are entered and the physical connection is up. These addresses are used for eBGP peering, such as similarly described above.

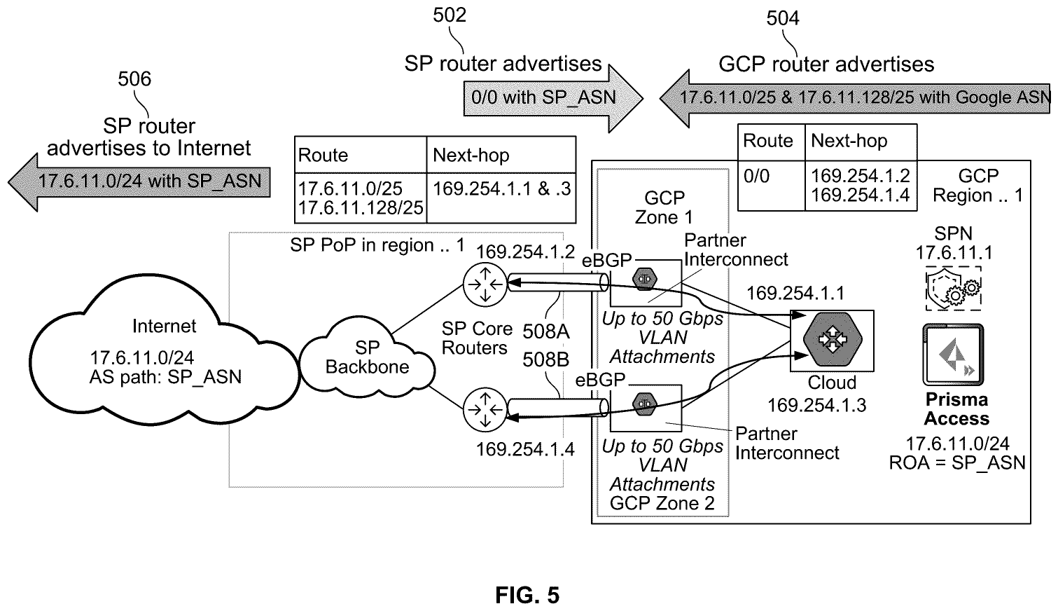

FIG. 5 is another block diagram that illustrates a control plane for eBGP routing for a SASE interconnect platform solution for any network fabric for providing enhanced security in accordance with some embodiments. As also discussed above, it would be apparent to one of ordinary skill in the art that the disclosed techniques can similarly be applied to various other example service partner/service provider environments.

Referring to FIG. 5, at 502, the SP router advertises 0/0 as shown.

At 504, the GCP router advertises the public IP addresses/prefixes as shown.

Specifically, 17.6.11.0/24 is an example of a public prefix for illustration purposes (e.g., split in/25 for allowing aggregation on the SP side). The public IP subnet can be provided either by the SASE cloud provider or the service provider (SP). The public IP subnet is registered with an SP ASN (e.g., in ARIN, see https://www.arin.net/resources/manage/rpki/roa_request/). The public IP subnet is configured on a per region basis. In this example implementation, the dual connections with eBGP provide active/active and resiliency.

At 506, the SP router advertises to the Internet. As shown, 17.6.11.0/24 with SP_ASN is advertised to the Internet as shown in FIG. 5. Specifically, in this example implementation, the SP builds an aggregate and using its own AS as originator then advertises to the Internet (e.g., Google ASN 16650 is not seen in the Internet).

As shown at 508A and 508B in FIG. 5, redundancy can be provided using the disclosed SASE interconnect solution for any fabric. Specifically, an Active-Active schema is provided such that the IPsec tunnels spread across the two interconnect links as shown at 508A and 508B. In this example implementation, from 1 Gbps up to 50 Gbps per Partner Interconnect link is provided (e.g., up to 100 Gbps in total (50×2)). Also, multiple links can be provided, and each Partner Interconnect link has one vLAN.

In an example implementation, the cloud router (e.g., as shown at 112 in FIG. 1 and at 112A in FIG. 2, which can be implemented using the GCP cloud router, see https://cloud.google.com/network-connectivity/docs/router/concepts/overview), is a fully distributed and managed Google Cloud service that uses the Border Gateway Protocol (BGP) to advertise IP prefixes. The cloud router programs dynamic routes based on the BGP advertisements that it receives from a peer. Instead of a physical device or appliance, each Cloud Router implements software tasks that act as BGP speakers and responders. For VLAN attachments, a separate software task handles each edge availability domain with attachments. Cloud Router maintenance is an automatic process, and it is designed so that it does not interrupt routing. Maintenance events are generally expected to take no more than 60 seconds. Before maintenance, the Cloud Router sends a graceful restart notification (e.g., a TCP FIN packet) to the on-premises router.

Additional example processes for the disclosed techniques for providing a SASE interconnect platform solution for providing enhanced security for any network fabric will now be further described below.

### Example Processes for a Service Access Service Edge (SASE) Interconnect Platform Solution for Any Network Fabric

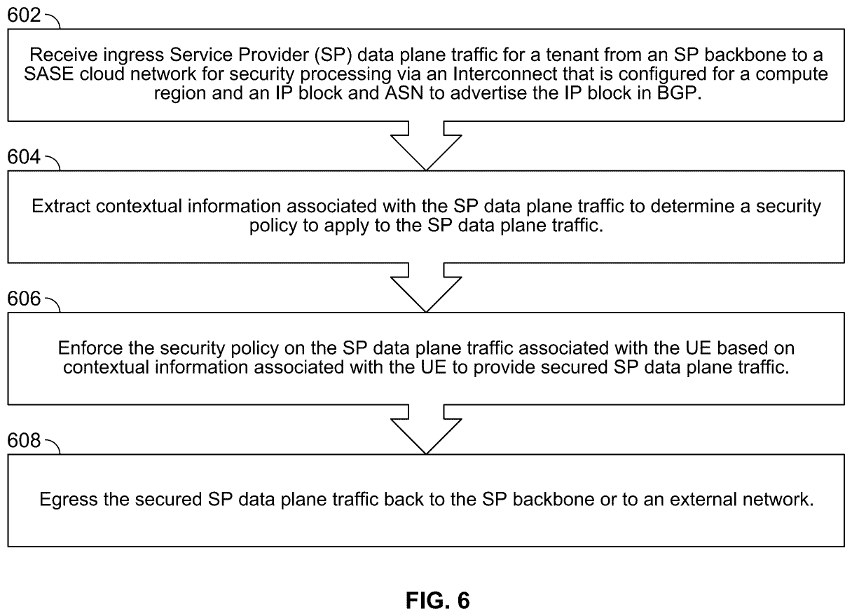

FIG. 6 is a flow diagram for a SASE interconnect platform solution for any network fabric for providing enhanced security in accordance with some embodiments. In some embodiments, a process as shown in FIG. 6 is performed by the SASE solution and techniques as similarly described above including the embodiments described above with respect to FIGS. 1-5. In one embodiment, the process is performed, at least in part, by 5G SPN clusters 114 as described above with respect to FIG. 1.

The process begins at 602. At 602, ingress Service Provider (SP) data plane traffic for a tenant from an SP backbone to a SASE cloud network for security processing is received via an Interconnect that is configured for a compute region and an IP block and Autonomous System Number (ASN) to advertise the IP block in Border Gateway Protocol (BGP). As similarly described above with respect to FIG. 1, a secure channel, such as an interconnect (e.g., a GCP interconnect or other cloud to cloud interconnect), can be used for securely transmitting traffic from the mobile core network to the SASE cloud network.

At 604, extracting contextual information associated with the SP data plane traffic (e.g., user traffic) to determine a security policy to apply to the SP data plane traffic is performed. In this example implementation, the contextual information can include IMSI, IMEI, MSISDN/external identifier, RAT type, Network Slice, DNN/APN, location, user/UE IP, app ID, user ID, and/or other contextual information.

At 606, enforcing the security policy on the traffic to provide secured SP data plane traffic using a Security Processing Node (SPN) is performed. For example, various enforcement actions (e.g., allow/pass, block/drop, alert, tag, monitor, log, throttle, restrict access, and/or other enforcement actions) can be performed using the security platform as similarly described above. As similarly described above with respect to FIGS. 1-5, the security policy can be determined and/or enforced based on various combinations of IMSI, IMEI, MSISDN/external identifier, RAT type, Network Slice, DNN/APN, location, user/UE IP, app ID, user ID, and/or other contextual information and/or based on information detected/determined using DPI-based firewall techniques, such as by performing URL filtering, identifying an Application-ID (app ID), identifying a Content-ID, and/or using other DPI-based firewall techniques as similarly described above.

At 608, egressing the secured SP data plane traffic back to the SP backbone or to an external network is performed. For example, the secured SP data plane traffic can be egressed to the Internet (e.g., Internet access or SaaS app access) and/or an enterprise data center, such as similarly described above with respect to FIGS. 1-5.

Example Processes for a Zero Trust Network Access Solution for 5G SASE with Explicit Proxy

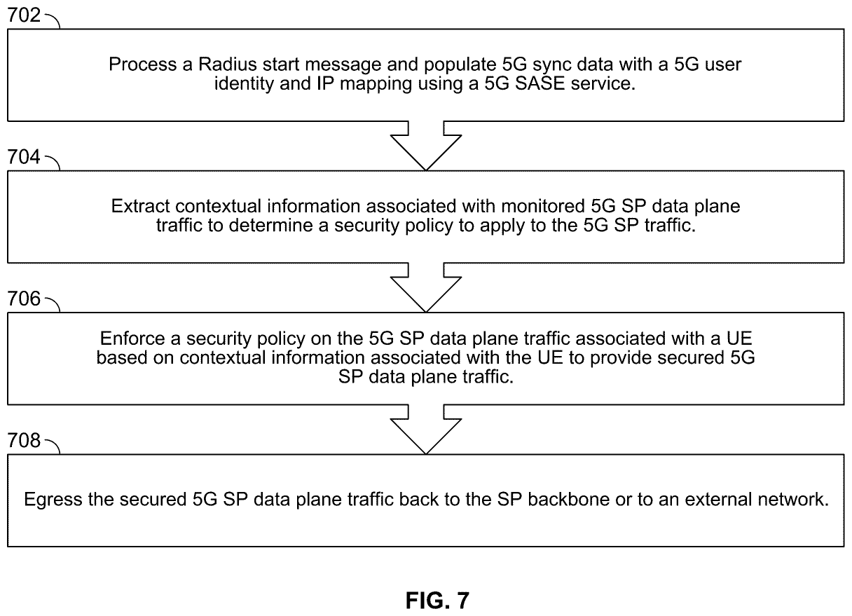

FIG. 7 is a flow diagram for a zero trust network access (ZTNA) solution for a 5G SASE with explicit proxy for providing enhanced security in accordance with some embodiments. In some embodiments, a process as shown in FIG. 7 is performed by the SASE solution and techniques as similarly described above including the embodiments described above with respect to FIGS. 1-5. In one embodiment, the process is performed, at least in part, by 5G SPN clusters 114 as described above with respect to FIG. 1.

The process begins at 702. At 702, process a Radius start message and populate 5G synchronized (sync) data with a 5G user identity and IP mapping using a 5G SASE service. For example, as similarly described above with respect to FIGS. 1-3, all the data path traffic and radius messages can be routed to and processed by the 5G SASE service, and the 5G user identity and IP mapping can be stored in the CIE (e.g., as shown at 250A in FIG. 2). Also, a service provider (SP) configures IMSI, IMEI, and APN information to identify UEs from each SP 5G network, and configures security policies per user group and/or individual users for the 5G SASE service. For example, the configuration can be performed using a SASE configuration portal under a managed service provider, such as similarly described above with respect to FIGS. 1-3. Also, the service provider can bring up an explicit proxy stack using a management tool for the 5G SASE service.

At 704, extracting contextual information associated with the 5G SP data plane traffic (e.g., user traffic) to determine a security policy to apply to monitored 5G SP data plane traffic is performed. In this example implementation, the contextual information can include IMSI, IMEI, MSISDN/external identifier, RAT type, Network Slice, DNN/APN, location, user/UE IP, app ID, user ID, and/or other contextual information.

At 706, enforcing a security policy on the 5G SP data plane traffic associated with the UE based on contextual information associated with the UE to provide secured 5G SP data plane traffic is performed. For example, security policies can be configured per enterprise tenant of the 5G SASE service.

At 708, egressing the secured 5G SP data plane traffic back to the SP backbone or to an external network is performed. For example, the secured 5G SP data plane traffic can be egressed to the Internet (e.g., Internet access or SaaS app access) and/or an enterprise data center, such as similarly described above with respect to FIGS. 1-5.

Although the foregoing embodiments have been described in some detail for purposes of clarity of understanding, the invention is not limited to the details provided. There are many alternative ways of implementing the invention. The disclosed embodiments are illustrative and not restrictive.

1. A system, comprising:
a processor configured to:
receive ingress Service Provider (SP) data plane traffic for a tenant from an SP backbone to a Secure Access Service Edge (SASE) cloud network for security processing via an Interconnect that is configured for a compute region and an IP block and an Autonomous System Number (ASN) to advertise the IP block in Border Gateway Protocol (BGP);
extract contextual information associated with the SP data plane traffic to determine a security policy to apply to the SP data plane traffic;
enforce the security policy on the SP data plane traffic to provide secured SP data plane traffic using a Security Processing Node (SPN); and
egress the secured SP data plane traffic back to the SP backbone or to an external network; and
a memory coupled to the processor and configured to provide the processor with instructions.

2. The system recited in claim 1, wherein SP data plane traffic includes IPsec and non-IPsec traffic that is processed and secured using the SPN in the SASE cloud network.

3. The system recited in claim 1, wherein the Interconnect is configured via a portal for the compute region and the IP block and the ASN to advertise the IP block in the BGP.

4. The system recited in claim 1, wherein the external network includes a tenant Data Center (DC) and/or an Internet.

5. The system recited in claim 1, wherein the contextual information is extracted using a Packet Forwarding Control Protocol (PFCP), a Radius protocol, a Diameter protocol, a Syslog message, an Application Programming Interface (API), and/or a Geneve protocol.

6. The system recited in claim 1, wherein the SPN includes a firewall as a service that is configured with a plurality of security policies based on a subscriber identity, a unique device identifier, a subscriber number, and an application identifier, wherein the subscriber identity includes an International Mobile Subscriber Identity (IMSI), wherein the unique device identifier includes an International Mobile Equipment Identifier (IMEI), and wherein the subscriber number includes a General Public Subscription Identifier (GPSI), a Mobile Station International Subscriber Director Number (MSISDN), and/or another external identifier.

7. The system recited in claim 1, wherein the SP data plane traffic is secured from and to 4G, 5G, and/or 6G UE devices.

8. The system recited in claim 1, wherein Internet access is secured from and to 4G, 5G, and/or 6G UE devices.

9. The system recited in claim 1, wherein enterprise data center access is secured from and to 4G, 5G, and/or 6G UE devices.

10. The system recited in claim 1, wherein selection and the enforcement of the security policy is based on the contextual information associated with a UE and the data plane traffic correlated with the UE based on a UE Internet Protocol (IP) address.

11. The system recited in claim 1, wherein the SPN includes a firewall as a service (FWaaS) associated with the SASE cloud network that is configured to perform Uniform Resource Link is (URL) filtering for the data plane traffic.

12. The system recited in claim 1, wherein the SPN includes a firewall as a service (FWaaS) associated with the SASE cloud network that is configured to perform application Denial of Service (DoS) detection for the data plane traffic.

13. The system recited in claim 1, wherein the SPN includes a firewall as a service (FWaaS) associated with the SASE cloud network that is configured to perform threat prevention, advanced threat prevention, and/or advanced Uniform Resource Link (URL) filtering for the SP data plane traffic.

14. The system recited in claim 1, wherein each of a plurality of security policies is distinctly selected and enforced for each mobile service provider (MSP) enterprise tenant at the SASE cloud network, wherein per tenant security policy configuration and enforcement are provided by the SASE cloud network.

15. The system recited in claim 1, wherein the data plane traffic is encapsulated with meta information, including a subscriber identity and/or a unique device identifier.

16. The system recited in claim 1, wherein the processor is further configured to:
determine the security policy to apply at the SASE cloud network to the SP data plane traffic based on a subscriber identity and/or a unique device identifier.

17. The system recited in claim 1, wherein the processor is further configured to:
receive a message over a network protocol from a mobile core network at the SASE cloud network, wherein contextual information associated with the message is communicated using a Packet Forwarding Control Protocol (PFCP), a Radius protocol, a Diameter protocol, Syslog messages, an Application Programming Interface (API), and/or a Geneve protocol.

18. The system recited in claim 1, wherein the processor is further configured to:
receive an accounting message from a mobile core network at the SASE cloud network, wherein contextual information associated with the accounting message is communicated using a DIAMETER protocol, a Radius protocol, and/or via an Application Programming Interface (API).

19. A method, comprising:
receiving ingress Service Provider (SP) data plane traffic for a tenant from an SP backbone to a Secure Access Service Edge (SASE) cloud network for security processing via an Interconnect that is configured for a compute region and an IP block and an Autonomous System Number (ASN) to advertise the IP block in Border Gateway Protocol (BGP);
extracting contextual information associated with the SP data plane traffic to determine a security policy to apply to the SP data plane traffic;
enforcing the security policy on the SP data plane traffic to provide secured SP data plane traffic using a Security Processing Node (SPN); and
egressing the secured SP data plane traffic back to the SP backbone or to an external network.

20. A computer program product, the computer program product being embodied in a tangible computer readable storage medium and comprising computer instructions for:
receiving ingress Service Provider (SP) data plane traffic for a tenant from an SP backbone to a Secure Access Service Edge (SASE) cloud network for security processing via an Interconnect that is configured for a compute region and an IP block and an Autonomous System Number (ASN) to advertise the IP block in Border Gateway Protocol (BGP);
extracting contextual information associated with the SP data plane traffic to determine a security policy to apply to the SP data plane traffic;
enforcing the security policy on the SP data plane traffic to provide secured SP data plane traffic using a Security Processing Node (SPN); and
egressing the secured SP data plane traffic back to the SP backbone or to an external network.
